(19) United States
(12) Patent Application Publication
(10) Pub. No.: US 2017/0115121 A1
(43) Pub. Date: Apr. 27, 2017

(54) Signposting System And Pathfinding Method

(71) Applicant: Siemens Aktiengesellschaft, Muenchen (DE)

(72) Inventor: Asa MacWilliams, Fuerstenfeldbruck (DE)

(73) Assignee: Siemens Aktiengesellschaft, Muenchen (DE)

(21) Appl. No.: 15/301,430

(22) PCT Filed: Dec. 8, 2014
(86) PCT No.: PCT/EP2014/076882

§ 371 Date: Oct. 3, 2016

(30) Foreign Application Priority Data
Apr. 3, 2014 (DE) 10 2014 206 422.8

(51) Int. Cl. G01C 21/20; H04W 4/04

(52) U.S. Cl. CPC G01C 21/206; H04W 4/04

(57) ABSTRACT

A method is disclosed for pathfinding in a building, wherein a user of a mobile terminal uses multiple navigation points installed in the building to determine a path to a desired destination in the building. The pathfinding uses the principle of next-hop forwarding used in routing protocols. For such packet switching, a packet switcher does not know the complete path to the packet's destination, but only the route to the next intermediate station or “next hop.” The collected path descriptions required at a respective position for successful navigation are short enough to record in the memory of a navigation point, e.g., a Bluetooth beacon. For successful indoor navigation, a short textual path description at the next respective fork in the path or distinctive location is sufficient to allow a user to find the path. Thus, effective pathfinding may be provided without accurate position finding or geometric location of the user.

### CROSS-REFERENCE TO RELATED APPLICATIONS

This application is a U.S. National Stage Application of international Application No. PCT/EP2014/076882 filed Dec. 8, 2014, which designates the United States of America, and claims priority to DE Application No. 10 2014 206 422.8 filed Apr. 3, 2014, the contents of which are hereby incorporated by reference in their entirety.

### TECHNICAL FIELD

The present invention relates to a signposting system and to a pathfinding method for pedestrians, in particular for finding a path for and locating pedestrians in a closed region.

### BACKGROUND

Signposting systems are used to enable pathfinding inside at least partially closed regions, for instance buildings or areas (for example company premises, airports, shopping malls, exhibition grounds). The users are typically people moving through an at least partially closed region on foot, also using escalators and elevators. Therefore, such signposting systems are also referred to as indoor navigation systems.

Known signposting systems are based on a mobile terminal which is used to determine a position of the terminal and of its user. The path to be determined is ascertained from a current position of the mobile terminal and a destination to be stipulated taking into account a building plan. The building plan stipulates all possible routes inside the at least partially closed region. An advantageous, that is to say shortest or fastest, route from the current position to the stipulated destination is determined using conventional route algorithms.

The known signposting systems have a number of disadvantages. On the one hand, widespread positioning methods using global positioning system (GPS) signals cannot be used in buildings since it is technically virtually impossible to receive GPS signals in buildings. Methods based on carrying out positioning at existing signal sources or signal sources yet to be installed inside buildings are currently being developed or refined.

In this case, positioning methods based on trilateration or “fingerprinting” by evaluating WLAN or Bluetooth signals can be mentioned, for example. Such radio positioning is associated with great disadvantages on account of a large amount of installation effort with still existing inaccuracies in the positioning.

The consideration of a building plan, which is necessary in conventional signposting systems, also has a number of disadvantages. This building plan is in the form of digital map material for a delimited region, for example of the building. Use of a building plan enables route planning and presentation which is not restricted to merely determining a beeline between the current position and the destination. Rather, a path via a route to be determined is planned and presented, which path is stored in the map material and is selected using a route algorithm. A first disadvantage of using a building plan already exists as a result of an amount of computing effort needed to store and evaluate this building plan. This is because the latter is transmitted to the mobile terminal, whereupon there is a high storage and processor power requirement for pathfinding on this mobile terminal.

Alternatively, the pathfinding is carried out on a central system. For this purpose, it is necessary for the mobile terminal to transmit the desired destination once and to continuously transmit the current position. The route algorithm is carried out on the central system which transmits current route instructions and possibly also current map representations of the building plan to the mobile terminal. In addition to a disadvantage of an increased data transmission volume, this variant entails the risk, in particular, of the data interchanged for the route calculation not being protected from unauthorized access.

### SUMMARY

One embodiment provides a pathfinding method for a user in an area divided into a plurality of predefined zones, a plurality of zones in the area having zone numbering based on a hierarchical numbering plan, the method comprising: (a) detecting when a mobile terminal assigned to the user approaches a navigation point; (b) reading a destination zone number held in the mobile terminal; (c) transmitting at least one path data identifier assigned to a zone number or zone number range from the navigation point to the mobile terminal; (d) selecting a path data identifier, the zone number of which matches the destination zone number or the zone number range of which comprises the destination zone number; (e) calling up a path description assigned to the path data identifier; and (f) outputting the path description on the mobile terminal.

In one embodiment, the method includes, following method step (b), the steps of (b1) transmitting the destination zone number to the navigation point and (b2) selecting, at the navigation point, at least one path data identifier, the zone number of which matches the destination zone number or the zone number range of which comprises the destination zone number; and the method also comprises, in place of steps (c) and (d) above, the step of (c) transmitting the at least one selected path data identifier to the mobile terminal.

In one embodiment, the path description assigned to the path data identifier is transmitted from the navigation point to the mobile terminal.

In one embodiment, the path description assigned to the path data identifier is transmitted from an external data source to the mobile terminal.

In one embodiment, the path description assigned to the path data identifier is obtained from a storage device of the mobile terminal.

In one embodiment, the path data identifier is an identification number.

In one embodiment, the respective zone number or the respective zone number range itself is used as the path data identifier.

In one embodiment, a zone number range comprising a plurality of zone numbers being defined to the effect that a digit matching at a digit position in all zone numbers is entered at the corresponding digit position of the zone number range; and a wildcard is entered at the corresponding digit position of the zone number range for a digit which differs from other zone numbers in at least one digit position.

In one embodiment, in the case of a zone number range, the pathfinding corresponds to store-and-forward switching in which next-hop forwarding is carried out to a navigation point following on a path of the user.

In one embodiment, the method includes zone numbering based on a hierarchical numbering plan, comprising at least one digit position for indicating a building number; at least one digit position for indicating a floor number; and/or at least one digit position for indicating a room number.

In one embodiment, when selecting a path data identifier, the zone number range of which comprises the destination zone number, that path data identifier whose zone number range more specifically comprises the destination zone number is preferably selected.

Another embodiment provides a navigation point for assisting with pathfinding for a user in an area divided into a plurality of predefined zones, a plurality of zones in the area having zone numbering based on a hierarchical numbering plan, comprising: a wireless interface which is set up to transmit data to a mobile terminal assigned to the user; a storage unit for storing a plurality of zone numbers and/or zone number ranges and a path data identifier assigned to a respective zone number or a respective zone number range; and a transmission unit for transmitting at least one path data identifier assigned to a zone number or zone number range to the mobile terminal via the wireless interface.

In one embodiment, the navigation point includes a storage unit for storing a plurality of path descriptions assigned to a respective path data identifier.

In one embodiment, the navigation point includes an interface to a computer system which can be connected, the interface being set up to edit and revise zone numbers, zone number ranges, path data identifiers and/or path descriptions.

Another embodiment provides a signposting system for assisting with pathfinding for a user, comprising: an area divided into a plurality of predefined zones, a plurality of zones in the area having zone numbering based on a hierarchical numbering plan; a plurality of navigation points as disclosed above installed in the area; and at least one mobile terminal on which a computer program for carrying out a method as disclosed above.

### BRIEF DESCRIPTION OF THE DRAWINGS

Example aspects and embodiments of the invention are explained in more detail below with reference to the drawing, wherein:

FIG. 1 shows a schematic illustration of functional components of a signposting system according to one embodiment; and

FIG. 2 shows a schematic illustration of path guidance in an area divided into a plurality of predefined zones, a plurality of zones in the area having zone numbering based on a hierarchical numbering plan.

### DETAILED DESCRIPTION

Embodiments of the invention provide a solution for pathfinding in at least partially closed regions, which solution can be implemented without accurate positioning and without using a resource-intensive building plan.

Some embodiments provide a pathfinding method for a user in an area divided into a plurality of predefined zones, a plurality of zones in the area having zone numbering based on a hierarchical numbering plan. The method according to the invention provides the following method steps which can be carried out without heeding the order described:

In a first step a), it is detected when a mobile terminal assigned to the user approaches a navigation point. The detection of an approach means, in particular, that no positioning is needed to carry out the method according to the invention. Instead, detection of an approach means only that the presence of the mobile terminal in the radio range of the navigation point is registered. The approach is detected by the mobile terminal and/or by the navigation point. The presence in the radio range is synonymous with visual contact between the user and the navigation point using familiar wireless communication technologies.

In a further step b), a destination zone number held in the mobile terminal is read. Like the general zone numbering, the destination zone number is organized according to a hierarchical numbering plan, according to which adjacent zones are numbered in ascending order, for example.

In a further step c), at least one path data identifier is transmitted from the navigation point to the mobile terminal, path data identifiers being assigned to a specific zone number or a zone number range.

In a further step d), a path data identifier, the zone number of which matches the destination zone number or the zone number range of which comprises the destination zone number, is selected. The selection of a path data identifier according to this specification follows store-and-forward switching according to the principle of next-hop forwarding in routing protocols. In the case of such packet switching, a packet switch does not know the complete path to the destination of the data packet but only the route to the next intermediate station or “next hop”. If this principle is used in a similar manner, the method according to the invention is used to check a destination zone number in order to determine whether a specific zone number which matches the destination zone number is already present. This situation usually occurs only when the user to be guided is already close to the desired destination. In addition to further zone numbers and zone number ranges, a navigation point there then also holds, for example, a specific zone number for the immediately adjacent destinations. In contrast, if the user to be guided is not yet in the vicinity of his destination, a specific zone number which matches the destination zone number is generally not yet present. On account of this, available non-specific zone number ranges are used to check in which of the zone number ranges held the destination zone number lies. For such a zone number range, the associated path data identifier which is assigned a path description to the next navigation point is selected. In a similar manner to store-and-forward switching, next-hop forwarding of the user to a navigation point following on a path of the user is therefore carried out at the current navigation point.

In a further step e), a path description assigned to the path data identifier is called up. The path description contains specific instructions for the user with the aim of pathfinding. Such specific instructions are preferably in linguistic form and take into account specific spatial features in the environment of the current navigation point. One example of a linguistic path description would be: “Enter through the blue door to your right and follow the corridor in the direction of the adjacent building”.

In a further step f), the path description is output, for example in graphical and/or in linguistic form, on the mobile terminal. An alternative or additional graphical representation comprises, for example, any desired pictograms for navigational representation, for example direction arrows, directional representations in the form of a compass, progress indicators which graphically represent a distance to the destination etc.

With respect to the order of the method steps, it can be noted that only step a) constitutes the beginning of the method, while method steps c) and d), in particular, can also be carried out in the opposite order. For example, according to a first embodiment, the path data identifier can first of all be transmitted from the navigation point to the mobile terminal according to step c), whereupon a path data identifier is selected on the terminal according to step d). However, according to a second embodiment, a path data identifier can also be first of all selected according to step d), in which case the selection is made in this second embodiment by the navigation point in a manner differing from the first embodiment. Only after one or else more path data identifiers have been selected are they transmitted from the navigation point to the mobile terminal according to step c).

Some embodiments are directed to a pathfinding method in a building, with a user of a mobile terminal determining a path to a desired destination in the building using a plurality of navigation points fitted in the building.

In contrast to current indoor navigation systems, embodiments of the invention may be distinguished, for example, by virtue of the fact that the disclosed pathfinding does not require the position of the mobile terminal to be determined. Some embodiments also advantageously do not require a building plan, the consideration of which has to be used to calculate a route from a current position of the mobile terminal and a destination to be stipulated in conventionally known indoor navigation systems using conventional route algorithms.

In contrast to these conventional methods, in a pathfinding solution which dispenses with the two resource-intensive measures mentioned above, the invention is based on another approach, namely the paradigm of persons who are familiar with the location and are questioned by a pedestrian on the way to his destination. For example, museum attendants provide a museum visitor with information relating to a direction to be taken on his way to a desired exhibition space. On the way to the desired exhibition space, the museum visitor receives further path descriptions from further museum attendants encountered by the museum visitor on his way.

The inventive motivation of simulating a museum attendant in a navigation point is accompanied by zone numbering based on a hierarchical numbering plan. A hierarchically constructed numbering plan comprises a class division which becomes finer with an increasing number of digits. The respectively coarser class must be known in order to be able to assign the meaning to the next finer class. Applied to the zone numbering used according to the invention, this provides, for example, a number of digit positions for indicating a building number, followed by digit positions for indicating a floor number and also followed by digit positions for indicating a room number. Such a hierarchically constructed numbering plan for zone numbering or room numbering is, for the rest, common practice anyway in building complexes, with the result that the use according to the invention does not signify any additional outlay. For example, the room numbering in hotels having only one building complex usually uses a multi-digit number in which the first digit indicates the floor, followed by a number of digits with ascending room numbering. The number of digits provided for continuous room numbering is two, three or higher, depending on the size of the hotel. In this case, a room number of 412 corresponds to room number 12 on the fourth floor. In the case of larger areas, for example company premises, a numbering plan is provided which comprises a building number or more generally: a building identification. Instead of numbers, it is also possible to alternatively use letters. A room number of 31.211 then means, for example, building 31, second floor, room 11. In a generalizing manner, reference is also made below to an area subdivided into a plurality of zones, the area corresponding to the hotel in the above example and a zone corresponding to a hotel room in this hotel.

The above-described principle of route switching provides a path description for a given destination zone number to the effect that the navigation points also hold path descriptions which are assigned to a zone number range.

Such a zone number range for the abovementioned room number 31.211 as the destination zone number would be 31.2*, for example, for the situation in which the user is in front of a navigation point on the second floor of the building 31. In this case, the asterisk (*) corresponds to a placeholder or wildcard for all zone numbers contained in the zone number range 31.2*. However, for the destination which is by and large on the current second floor, even more specific zone number ranges may be available, for example a zone number range 31.2* (1-99) or a zone number range 31.2* (9-15, odd number). The above mentioned notation 31.2* (1-99) can be understood as meaning a zone number range which begins with the zone number 31.201 and ends with the zone number 31.299. The above mentioned notation 31.2* (9-15, odd number) can be understood as meaning a zone number range which begins with the zone number 31.209 and ends with the zone number 31.215 and which contains only odd numbers for the last two digits. In other words, the zone number range 31.2* (9-15, odd number) mentioned last comprises the zone numbers 31.009, 31.011, 31.013. The zone number range 31.2* (9-15, odd number) mentioned last is here the most specific zone number range for the given destination zone number 31.211, with the result that a path data identifier assigned to this zone number range and a path description assigned to this path data identifier are selected in one configuration of the invention.

A zone number range is therefore formed, for example, in such a manner that a digit matching at a digit position in all zone numbers is entered at the corresponding digit position of the zone number range and a placeholder or wildcard is entered at the corresponding digit position of the zone number range for a digit which differs from other zone numbers in at least one digit position. Furthermore, characterizations which can be processed using computing, such as “odd number”, can be added for the purpose of characterizing the zone number range.

If the user is in front of a navigation point in another building having the number 32, a different zone number range should be selected for the destination zone number, for example 31.*. The destination in the building 31 is therefore initially outside the current building 32, with the result that the path guidance must initially be given to the exit on the ground floor of the current building 32. A path data identifier assigned to the zone number range 31.* and a path description assigned to this path data identifier would accordingly first of all guide the user to the exit of the building 32 as the “next hop”. It should be stressed at this point that zone number ranges and, in particular, assigned path descriptions generally need to be specifically defined for each navigation point. Only destinations which are further away, such as the zone number range 31.* mentioned, result in a path description to the exit on the ground floor of the current building 32 for all navigation points in the building 32.

The disclosed means can be advantageously implemented without communicating with a server. The mobile terminal also does not need to disclose the user's destination to the navigation points. The invention may therefore protect the user's privacy.

The user to be navigated always receives all information which he could also receive if he were to study orientation boards fitted at numerous locations, but without esthetically impairing the area as a result of numerous orientation boards and, in particular, without having to read through all possible destinations, using the disclosed means.

Other embodiments provide a navigation point including:
a wireless interface which is set up to transmit data to a mobile terminal assigned to the user;
a storage unit for storing a plurality of zone numbers and/or zone number ranges and a path data identifier assigned to a respective zone number or a respective zone number range;
a transmission unit for transmitting at least one path data identifier assigned to a zone number or zone number range to the mobile terminal via the wireless interface.

Other embodiments provide a signposting system for assisting with pathfinding for a user. The signposting system may include:
an area divided into a plurality of predefined zones, a plurality of zones in the area having zone numbering based on a hierarchical numbering plan;
a plurality of navigation points as disclosed herein installed in the area;
at least one mobile terminal on which a computer program for carrying out a method as disclosed herein.

Embodiments of the disclosed signposting system can be advantageously used, for example, by operators of airports and train stations, operators of department stores and shopping centers, tourism companies and hotel operators, trade fair operators, universities, housing companies, organizers of large events, operators of museums and libraries, authorities, agencies or company headquarters and operators of hospitals.

According to one embodiment, after the destination zone number held in the mobile terminal has been read, provision is made for this number to be transmitted to the navigation point. In the navigation point, at least one path data identifier, the zone number of which matches the destination zone number or the zone number range of which comprises the destination zone number, is selected. These preselected path data identifiers are then transmitted to the mobile terminal, optionally together with the respectively associated zone number range or the respectively associated zone number. Whereas, according to the present disclosure, a configuration is initially obvious in which all zone numbers and zone number ranges held in the navigation point are transmitted to the mobile terminal, together with the assigned path data identifier, in order to select there the zone number range or zone number matching the given destination zone number, it may be more advantageous to already make a selection in the navigation point in order to speed up the transmission or to avoid using storage space resources in the mobile terminal. This configuration largely corresponds, for the rest, to the configuration of embodiments of the invention explained above in which step d) is carried out before step c) in terms of time.

In some embodiments, the path descriptions assigned to path data identifiers may be stored in the navigation point and for one or more path descriptions to be transmitted from the navigation point to the mobile terminal. This configuration is appropriate for easily implementing software which runs on the mobile terminal and is set up to implement the signposting system and to communicate with navigation points.

In one embodiment of the method, the path descriptions assigned to the path data identifiers are stored in an external data source and for one or more path descriptions to be transmitted from the external database to the mobile terminal. This configuration is appropriate for an implementation in which the storage space available in the navigation point is limited. In this embodiment, a path data identifier is transmitted to a server, for example, which returns the path descriptions assigned to the path data identifier to the mobile terminal.

In another embodiment, the path descriptions assigned to the path data identifiers are obtained from a storage device of the mobile terminal. This configuration is appropriate for an implementation in which the storage space available in the navigation point is limited. This configuration is appropriate for implementing the software which runs on the mobile terminal and uses locally stored path descriptions.

The path data identifier is either an identification number or alternatively the respective zone number or the respective zone number range itself. In the last case, steps d) and e) of the method according to some embodiments are simplified to the steps of

d) selecting a zone number matching the destination zone number or a zone number range comprising the destination zone number;
e) calling up a path description assigned to the zone number or the zone number range;
with steps a), b), c) and f) which otherwise remain the same.

In one embodiment, a zone number range comprising a plurality of zone numbers is defined to the effect that a digit matching at a digit position in all zone numbers is entered at the corresponding digit position of the zone number range; and a wildcard is entered at the corresponding digit position of the zone number range for a digit which differs from other zone numbers in at least one digit position. The abovementioned “digit” is not restricted to numbers, but rather may also comprise letters and other types of typographical characters.

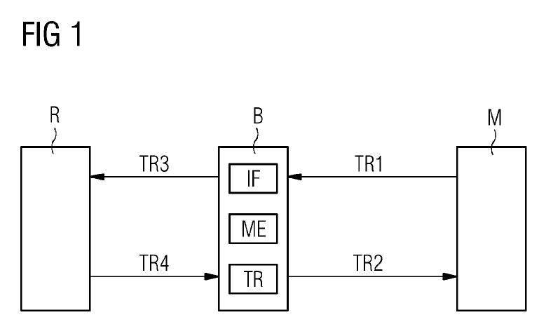

FIG. 1 shows a schematic illustration of functional components of a signposting system according to one embodiment of the invention.

Software (not illustrated) which is set up to implement the signposting system and to communicate with navigation points runs on a mobile terminal. This software can be installed as an application or “app” in a manner conventional for terminals, for example if the user enters the area, or can be downloaded if necessary, for instance if the user has become lost and now requires assistance. In order to facilitate acquisition of the application, a QR code used as a reference to an installation source or an NFC tag can be fitted to an orientation sign.

The mobile terminal M which enters the transmission range of a navigation point B is detected by the navigation point B. The navigation point B has a wireless interface IF which, according to a first embodiment, is set up to detect an approach of the mobile terminal M.

According to one embodiment, the approach is not detected at the navigation point, but rather solely at the mobile terminal. According to this embodiment, the navigation point transmits the data to be described in more detail below independently of a possible communication partner, that is to say preferably permanently, for example in cyclic repetitions. This measure allows the user's privacy to be improved further since, according to this embodiment, unauthorized access, for example by manipulating the navigation point or by listening in on the message traffic between the terminal and the navigation point, is technically excluded.

The communication protocol implemented via the wireless interface preferably operates according to the industrial standard in accordance with IEEE 802.15.1, also known as Bluetooth, in particular Bluetooth 4.0 or Bluetooth Low Energy, or else according to a local radio network of the IEEE 802.11 family, also known as WLAN or WiFi. Such a navigation point B is also known under the designation Bluetooth emitter or beacon among experts.

The approach of a mobile terminal is determined, according to the embodiment described here, by the navigation point, for example by interchanging connection messages managed by a software routine on the mobile terminal M side. In this case, the software routine is assigned to the software which runs on the mobile terminal and is set up to implement the signposting system and to communicate with navigation points B.

After an approach has been detected, the mobile terminal transmits the destination zone number held in the mobile terminal M to the navigation point B with a first message TR1.

There are two possible ways of interchanging data between the mobile device M and the navigation point B. The navigation point B preferably informs the mobile terminal M of all path data identifiers and associated path descriptions, whereupon the mobile terminal selects the appropriate path data identifier. If, however, there is a very large number of path data identifiers and associated path descriptions at a navigation point B, it may be more useful if the mobile terminal M initially informs the navigation point B of the destination zone number and the navigation point B returns only the appropriate path description. This embodiment mentioned last is explained below.

A storage unit ME of the navigation point B stores a plurality of zone numbers and/or zone number ranges and a path data identifier assigned to a respective zone number or a respective zone number range.

A path data identifier, the zone number of which matches the destination zone number or the zone number range of which comprises the destination zone number, is selected in a processing unit (not illustrated) of the mobile terminal M. In this configuration, one or more path data identifiers, the zone number of which matches the destination zone number or the zone number range of which comprises the destination zone number, are therefore selected or at least preselected by the navigation point B.

In order to avoid considerable storage resources in the navigation point B, provision may be made, like in the present exemplary embodiment, for the path description assigned to a respective path data identifier to be obtained from an external data source R. For this purpose, the navigation point B transmits, via the wireless interface IF or via an alternative wired data connection (not illustrated), a corresponding third request message TR3 which contains the path data identifier and is answered by the external data source R with a fourth message TR4 containing the desired path descriptions.

In order to avoid considerable storage resources in the navigation point B, provision may be alternatively made, according to an alternative exemplary embodiment which is not illustrated in the drawing, for the path description assigned to a respective path data identifier to be obtained from an external data source R by virtue of the mobile terminal M transmitting a request message (not illustrated) containing the path data identifier to the external data source R, which message is answered by the external data source R with a message (not illustrated) to the mobile terminal M containing the desired path descriptions.

In a transmission unit TR, a transmission of at least one path data identifier assigned to a zone number or a zone number range in the form of a second transmission message TR2 is generated and is transmitted to the mobile terminal M via the wireless interface IF.

The wireless interface IF of the navigation point B is also used as an interface to a computer system which can be connected, which interface is used to edit and revise zone numbers, zone number ranges, path data identifiers and/or path descriptions at the navigation point B.

Further embodiments whose features can also be freely chosen individually or in combination for a technical implementation are explained below.

In summary, there are some alternatives for the storage locations of the data:
According to the embodiment described above, the path descriptions are not stored in the navigation points B themselves, but rather on a server; only a path data identifier or identification number associated with the appropriate path descriptions on the server is stored in the navigation point B;
According to an alternative embodiment, the path descriptions are not stored in the navigation points B themselves, but rather on a server; only an indication of the logical position (for example building 31, second hall, central region) is held in the navigation point B; the appropriate path description is retrieved for this purpose on the server;
According to an alternative embodiment, the path descriptions are not stored in the
navigation points B themselves, but rather on the mobile terminal M; only an identification number associated with the appropriate path descriptions on the mobile terminal M is stored in the navigation point B. The mobile terminal M in turn obtains the path descriptions and identification numbers in a delivery from a server, for example if the person enters the area;
According to an alternative embodiment, the path descriptions are not stored in the navigation points B themselves, but rather on the mobile terminal M; only an indication of the logical position (for example building 31, second hall, central region) is held in the navigation point B; the mobile terminal M retrieves the appropriate path description for this purpose. The mobile terminal M in turn obtains the path descriptions and logical positions in a delivery from a server, for example if the person enters the area.

Further embodiments with regard to the organization of the contents communicated by the navigation points B are outlined below:
Navigation points B which can dynamically change their path descriptions because a particular path is blocked, for example;
Navigation points B which can dynamically change their path descriptions because their current position changes, for example a navigation point B in an elevator or in a train carriage;
A mobile system for programming the navigation points B, for instance on a tablet PC. For this purpose, a service engineer regularly inspects navigation points B in the area and edits, checks or updates the stored path descriptions;
A server-based system for programming the navigation points B: the navigation points B are networked to a server and are provided with new path descriptions from this server. A service engineer checks
and updates the stored path descriptions from his workstation.
A server-based system for programming the navigation points B, a server independently calculating and updating the current path descriptions for the navigation points B.
A server-based or terminal-based system which knows the information relating to all navigation points B (and possibly programs them). This system can be used by the user to gain an overview of the entire path to the destination at the start of a navigation task.

According to another embodiment, navigation points B may be fitted at locations where conventional signs are also provided for orientation in the area. In addition, some navigation points B can be provided with a large display and can therefore themselves become orientation signs, with the result that the system also becomes usable for persons without an appropriate mobile device. In the variant in which these navigation points B are connected to a central server, this configuration allows the orientation signs to be dynamically programmed in the area.

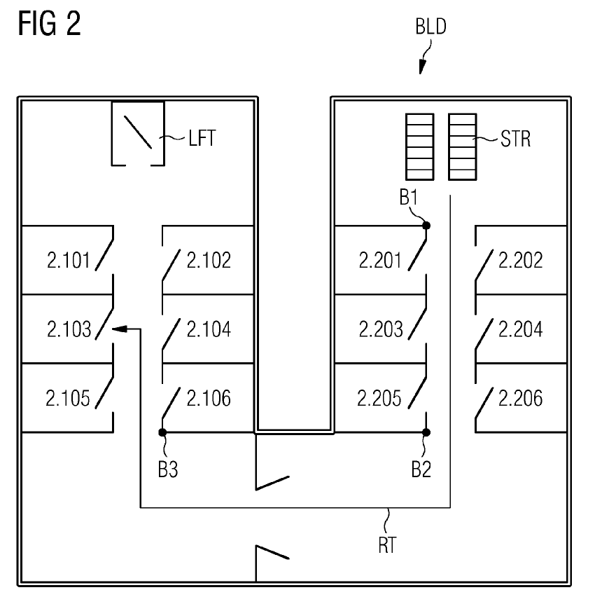

FIG. 2 shows a floor plan of an area BLD. In the situation shown, the area is a U-shaped building BLD comprising of a wing or building part 1 illustrated on the left and a building part 2 illustrated on the right. The floorplan shows the second floor of the building. Each room in the floorplan illustrated is provided with a room number or zone number 2.101, 2.102, 2.103, 2.104, 2.105, 2.106, 2.201, 2.202, 2.203, 2.204, 2.205, 2.206. In accordance with hierarchical numbering, the zone numbers illustrated begin with the number of the floor “2”, followed by a dot “.”, again followed by a building part number “1” or “2” and finally followed by a two-digit room number “01” . . . “06” which, in each wing, begins at the top left with a one or “01” and is respectively incremented on the opposite side, with the result that even room numbers are respectively part of the zone number in the right-hand region of the respective wing and odd room numbers are respectively part of the zone number in the left-hand region of the respective wing. The two wings are connected in the lower part of the building BLD by a hall having an access door. An elevator LFT is provided at the end of the first left-hand wing and a staircase STR is provided at the end of the second right-hand wing. A multiplicity of navigation points are provided in the entire area BLD, only three navigation points B1, B2, B3 of which are illustrated in FIG. 2.

It is now assumed below that a user on a route RT from the staircase in the second, right-hand wing wishes to reach a room with the zone number 2.103. As illustrated in the drawing, the route RT leads down through the second, right-hand wing, branches to the left in the drawing (to the right from the user's point of view) through the hall having the access door and leads up (to the right from the user's point of view) in the first, left-hand wing.

Upon leaving the staircase STR, an approach of a mobile terminal assigned to the user is detected in the effective range of the first navigation point B1. The destination zone number 2.103 held in the mobile terminal is read in the mobile terminal, but is not necessarily transmitted to the navigation point B1 in this exemplary embodiment. On account of the detected approach, the navigation point B1 now transmits a plurality of path data identifiers assigned to a zone number or a zone number range, including a path description assigned to the respective path data identifier, to the mobile terminal. The following table shows a selection of possible path data identifiers.

| Path data | Zone number | | Path |
|---|---|---|---|
| identifier | range | Zone number | description |
| W1 | 1.* | — | “Go back to |
| | | | the staircase |
| | | | and go down to |
| | | | the first |
| | | | floor” |
| W2 | 3.* | — | “Go back to |
| | | | the staircase |
| | | | and go up to |
| | | | the third |
| | | | floor” |
| W3 | 2.2* (odd) | — | “Go straight |
| | | | ahead in the |
| | | | corridor, the |
| | | | destination is |
| | | | on the right” |
| W4 | 2.2* (even) | — | “Go straight |
| | | | ahead in the |
| | | | corridor, the |
| | | | destination is |
| | | | on the left” |
| W5 | 2.1* | — | “Go straight |
| | | | ahead in the |
| | | | corridor, turn |
| | | | right at the |
| | | | end of the |
| | | | corridor, |
| | | | through the |
| | | | wing door, |
| | | | then turn |
| | | | right into the |
| | | | corridor” |
| W6 | — | 2.201 | “Go straight |
| | | | ahead in the |
| | | | corridor, then |
| | | | into the first |
| | | | room on the |
| | | | right-hand |
| | | | side” |
| . . . | . . . | . . . | . . . |

The destination zone number 2.103 held in the terminal is compared with all received data. Only the zone number range “2.1*” assigned to the path data identifier W5 comprises the destination zone number 2.103 and there is also no more specific or narrower zone number range. The path data identifier W5 is selected and the path description “Go straight ahead in the corridor, turn right at the end of the corridor, through the wing door, then turn right into the corridor” assigned to this path data identifier W5 is called up. This path description is finally output in acoustic and/or visual form on the user's mobile terminal.

The user now follows the path description and goes along the corridor, downward in the drawing. At the end of the corridor, an approach of the mobile terminal assigned to the user is detected in the effective range of the second navigation point B2. The destination zone number 2.103 held in the mobile terminal is read. On account of the detected approach, the navigation point B2 transmits a plurality of path data identifiers assigned to a zone number or a zone number range, including a path description assigned to the respective path data identifier, to the mobile terminal. The following table shows a selection of possible path data identifiers.

| Path data | Zone number | | Path |
|---|---|---|---|
| identifier | range | Zone number | description |
| W7 | 1.* | — | “Go into the |
| | | | corridor to |
| | | | the staircase |
| | | | and go down to |
| | | | the first |
| | | | floor” |
| W8 | 3.* | — | “Go into the |
| | | | corridor to |
| | | | the staircase |
| | | | and go up to |
| | | | the third |
| | | | floor” |
| W9 | 2.2* (odd) | — | “Go straight |
| | | | ahead in the |
| | | | corridor, the |
| | | | destination is |
| | | | on the left” |
| W10 | 2.2* (even) | — | “Go straight |
| | | | ahead in the |
| | | | corridor, the |
| | | | destination is |
| | | | on the right” |
| W11 | 2.1* | — | “Go through |
| | | | the wing door, |
| | | | then turn |
| | | | right into the |
| | | | corridor” |
| W12 | — | 2.201 | “Go straight |
| | | | ahead in the |
| | | | corridor, then |
| | | | into the last |
| | | | room on the |
| | | | left-hand |
| | | | side” |
| . . . | . . . | . . . | . . . |

The destination zone number 2.103 is compared with all received data. Only the zone number range “2.1*” assigned to the path data identifier W11 comprises the destination zone number 2.103. The path data identifier W11 is selected and the path description “Go through the wing door, then turn right into the corridor” assigned to this path data identifier W11 is called up. This path description is finally output in acoustic and/or visual form on the user's mobile terminal.

The user now follows the path description and goes through the wing door. At the start of the corridor, an approach of the mobile terminal assigned to the user is detected in the effective range of the third navigation point B3. The destination zone number 2.103 held in the mobile terminal is read. On account of the detected approach, the navigation point B3 transmits a plurality of path data identifiers assigned to a zone number or a zone number range, including a path description assigned to the respective path data identifier, to the mobile terminal. The following table shows a selection of possible path data identifiers.

| Path data | Zone number | | Path |
|---|---|---|---|
| identifier | range | Zone number | description |
| W13 | 1.* | — | “Go into the |
| | | | corridor to |
| | | | the elevator |
| | | | and go down to |
| | | | the first |
| | | | floor” |
| W14 | 3.* | — | “Go into the |
| | | | corridor to |
| | | | the elevator |
| | | | and go up to |
| | | | the third |
| | | | floor” |
| W15 | 2.1* (odd) | — | “Go straight |
| | | | ahead in the |
| | | | corridor, the |
| | | | destination is |
| | | | on the left” |
| W16 | 2.1* (even) | — | “Go straight |
| | | | ahead in the |
| | | | corridor, the |
| | | | destination is |
| | | | on the right” |
| W17 | 2.2* | — | “Go through |
| | | | the wing door, |
| | | | then turn left |
| | | | into the |
| | | | corridor” |
| W18 | — | 2.105 | “Go straight |
| | | | ahead in the |
| | | | corridor, then |
| | | | into the first |
| | | | room on the |
| | | | left-hand |
| | | | side” |
| W19 | — | 2.106 | “Go straight |
| | | | ahead in the |
| | | | corridor, then |
| | | | into the first |
| | | | room on the |
| | | | right-hand |
| | | | side” |
| W20 | — | 2.103 | “Go straight |
| | | | ahead in the |
| | | | corridor, then |
| | | | into the |
| | | | second room on |
| | | | the left-hand |
| | | | side” |
| . . . | . . . | . . . | . . . |

The destination zone number 2.103 is compared with all received data. The zone number range “2.1* (odd)” assigned to the path data identifier W15 indeed comprises the destination zone number 2.103 without there also being a more specific zone number range. However, there is a path data identifier W20, the zone number 2.103 of which matches the destination zone number 2.103. The path data identifier W20 is selected and the path description “Go straight ahead in the corridor, then into the second room on the left-hand side” assigned to this path data identifier W20 is called up. This path description is finally output in acoustic and/or visual form on the user's mobile terminal.

While the user moves through the area, current partial path descriptions are automatically obtained by the mobile terminal from the respective next navigation point and are displayed to the user. Therefore, the user advantageously need not continuously interact with the signposting system. A brief glance at the display of the mobile terminal suffices, if necessary.

The table of the entries assigned to path data identifiers explained above can also, for the rest, be extended with entries, that is to say additional path data identifiers with associated path descriptions, which provide details of the specific needs of a user. For example, the table may also include a path description which, despite a diversion to the elevator, instead leads to the staircase. This path data identifier can be provided with an identifier “barrier-free”. A disabled user can set a corresponding mark in options of his software running on his mobile terminal in order to cause a barrier-free path data identifier to be selected. A similar mark “path outdoors outside a building” can also be provided in the case of path data identifiers in which the proposed path runs outdoors. In the case of weather conditions with precipitation, alternative paths can be proposed which lead, for example, through a basement of an accordingly more spacious area. These weather conditions with precipitation can be derived, for example, from a weather forecast available on the mobile terminal.

The table of the entries assigned to path data identifiers explained above can furthermore also be extended with entries, that is to say additional path data identifiers with associated path descriptions, which each contain more specific path descriptions, the more specific path descriptions being formulated on the basis of the direction from which the user comes. In other words, the history of zone numbers which have already been passed is taken into account in the mobile terminal, for example, in order to make the direction statements more specific in path descriptions. In the example above, the path data identifier W7 held at the navigation point B2 could be extended with a path data identifier W7-1 in order to offer a direction statement which is more specific after previously passing the navigation point B1:

| Path data | Zone number | | Path |
|---|---|---|---|
| identifier | range | Zone number | description |
| . . . | . . . | . . . | . . . |
| W7 | 1.* | — | “Go into the |
| | | | corridor to |
| | | | the staircase |
| | | | and go down to |
| | | | the first |
| | | | floor” |
| W7-1 | 1.* | — | “Go back into |
| | | | the corridor |
| | | | to the |
| | | | staircase and |
| | | | go down to the |
| | | | first floor” |
| . . . | . . . | . . . | . . . |

The additional path data identifier W7-1 described above with the path description “Go back into the corridor to the staircase and go down to the first floor” is provided with a direction statement “back” which has been expanded in comparison with the path description assigned to the path data identifier W7. The fact that the user has already passed the corridor is derived from the fact, which is known on the mobile terminal M for example, that the user currently in the radio range of the navigation point B2 has previously passed through the radio range of the navigation point B1 and consequently, for example on account of a wrongly taken path, must go back through the corridor again in order to reach his destination.

The path descriptions can also be more specific than described above, for example in the form “Enter the corridor through a mixed glass door with the inscription ‘laboratory area’”.

In addition to the hierarchical numbering plan, further information, for example department names, may also be stored. If the hierarchical modeling of the department names can be well mapped to the hierarchical modeling of the area, this information can be extensively stored in the navigation points in the area; alternatively also only in the navigation points in the building in which a respectively referenced department is situated.

Embodiments of the present provide a pathfinding method in a building, a user of a mobile terminal determining a path to a desired destination in the building using a plurality of navigation points fitted in the building. The pathfinding is carried out in store-and-forward switching according to the principle of next-hop forwarding in routing protocols. In the case of such packet switching, a packet switch does not know the complete path to the destination of the data packet but rather only the route to the next intermediate station or “next hop”. The collected path descriptions which are required at a respective position for successful navigation are short enough to be able to be recorded in the memory of a navigation point, for example a Bluetooth beacon. For successful indoor navigation, a short textual path description at the respective next fork or distinctive location is sufficient to allow a user to find a path. Accurate positioning or geometrical localization is advantageously unnecessary for this purpose.

What is claimed is:

1. A pathfinding method for a user in an area divided into a plurality of predefined zones, a plurality of zones in the area having zone numbering based on a hierarchical numbering plan, the method comprising:
(a) detecting a mobile terminal assigned to the user approaching a navigation point;
(b) reading a destination zone number stored in the mobile terminal;
(c) transmitting at least one path data identifier assigned to a zone number or zone number range from the navigation point to the mobile terminal;
(d) selecting a path data identifier having an assigned zone number that matches a destination zone number or zone number range that comprises the destination zone number;
(e) acquiring a path description assigned to the path data identifier; and
(f) outputting the path description via the mobile terminal.

2. (canceled)

3. The method of claim 1, wherein the path description assigned to the path data identifier is transmitted from the navigation point to the mobile terminal.

4. The method of claim 1, wherein the path description assigned to the path data identifier is transmitted from an external data source to the mobile terminal.

5. The method of claim 1, wherein the path description assigned to the path data identifier is acquired from a storage device of the mobile terminal.

6. The method of claim 1, wherein the path data identifier is an identification number.

7. The method of claim 1, wherein the respective zone number or the respective zone number range itself is used as the path data identifier.

8. The method of claim 1, wherein a zone number range includes a plurality of zone numbers defined such that a digit matching at a digit position in all zone numbers is entered at the corresponding digit position of the zone number range; and a wildcard is entered at the corresponding digit position of the zone number range for a digit which differs from other zone numbers in at least one digit position.

9. The method of claim 1, wherein, for a zone number range, the pathfinding corresponds to store-and-forward switching in which next-hop forwarding is performed to a navigation point following on a path of the user.

10. The method of claim 1, comprising performing a zone numbering based on a hierarchical numbering plan, comprising at least one of:
at least one digit position indicating a building number;
at least one digit position indicating a floor number; or
at least one digit position indicating a room number.

11. The method of claim 1, wherein selecting a path data identifier comprises selecting the zone number range that most specifically includes the destination zone number.

12. A navigation point for assisting with pathfinding for a user in an area divided into a plurality of predefined zones, a plurality of zones in the area having zone numbering based on a hierarchical numbering plan, the navigation point comprising:
a wireless interface that transmits data to a mobile terminal assigned to the user;
a storage unit that stores a plurality of zone numbers and/or zone number ranges and a path data identifier assigned to a respective zone number or a respective zone number range; and
a transmission unit that transmit at least one path data identifier assigned to a zone number or zone number range to the mobile terminal via the wireless interface.

13. The navigation point of claim 11, comprising a storage unit that stores a plurality of path descriptions assigned to a respective path data identifier.

14. The navigation point of claim 12, comprising an interface to a computer system, the interface configured to edit and revise at least one of zone numbers, zone number ranges, path data identifiers, or path descriptions.

15. A signposting system for assisting with pathfinding for a user, the signposting system comprising:
an area divided into a plurality of predefined zones, a plurality of zones in the area having zone numbering based on a hierarchical numbering plan;
a plurality of navigation points installed in the area, each navigation point comprising:
a wireless interface that transmits data to a mobile terminal assigned to the user;
a storage unit that stores a plurality of zone numbers and/or zone number ranges and a path data identifier assigned to a respective zone number or a respective zone number range; and
a transmission unit that transmits at least one path data identifier assigned to a zone number or zone number range to the mobile terminal via the wireless interface; and
at least one mobile terminal on which a computer program for carrying out a method including:
detecting a mobile terminal assigned to the user approaching a navigation point;
reading a destination zone number stored in the mobile terminal;
transmitting at least one path data identifier assigned to a zone number or zone number range from the navigation point to the mobile terminal;
selecting a path data identifier having an assigned zone number that matches a destination zone number or zone number range that comprises the destination zone number;
acquiring a path description assigned to the path data identifier; and
outputting the path description via the mobile terminal.

16. A pathfinding method for a user in an area divided into a plurality of predefined zones, a plurality of zones in the area having zone numbering based on a hierarchical numbering plan, the method comprising:
detecting a mobile terminal assigned to the user approaching a navigation point;
reading a destination zone number stored in the mobile terminal;
transmitting the destination zone number to the navigation point;
selecting, by the navigation point, at least one path data identifier having an associated zone number that matches a destination zone number or zone number range that comprises the destination zone number;
transmitting the at least one selected path data identifier to the mobile terminal;
acquiring a path description assigned to the path data identifier; and
outputting the path description via the mobile terminal.
